(19) United States
(12) Patent Application Publication
(10) Pub. No.: US 2006/0181430 A1
(43) Pub. Date: Aug. 17, 2006

(54) Method and apparatus for automatically recognizing/establishing remote-controller communication mode for use in digital electronic devices

(75) Inventors: Jang-Sun Choi, Seoul (KR); Seong-Tae Hong, Seoul (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/333,254

(22) Filed: Jan. 18, 2006

(30) Foreign Application Priority Data
Jan. 19, 2005 (KR) 10-2005-0005127

(51) Int. Cl. G08C 19/00

(52) U.S. Cl. 340/825.72; 340/825.22

(57) ABSTRACT

A method and system for automatically recognizing/establishing a remote-controller communication mode for a digital electronic device is disclosed. The method includes the steps of: selecting a communication mode setup menu so as to allow a user to establish a remote-controller communication mode; allowing a remote-controller to generate a key input signal, and transmitting the key input signal to the digital electronic device; determining whether a Radio Frequency (RF) remote-controller signal is received; if the RF signal is received, controlling the digital electronic device to determine the remote-controller communication mode to be an RF mode, and outputting normal setup confirmation information; and e) allowing the user to check whether the remote-controller communication mode of the digital electronic device is switched to a user-desired mode. Therefore, the method automatically detects a remote-controller input signal of the digital electronic device, and easily establishes a user-desired communication mode, such that the possibility of a malfunction in the digital electronic device is reduced, and users of the digital electronic device can easily and conveniently select a remote-controller input mode or signal.

### BACKGROUND OF THE INVENTION

1. Field of the Invention

The present invention relates to a method and system for automatically recognizing/establishing a remote-controller communication mode for use in digital electronic devices.

2. Description of the Related Art

A remote-controller key value of a television (TV) is configured in the form of a predetermined input pattern composed of specific symbols indicative of two values 0 and 1. The above-mentioned input pattern is identified according to time information of a header or waveform of pulse generation.

Remote-controllers are classified into an IR-based remote-controller and an RF-based remote-controller according to key value output methods. The IR-based remote-controller signal travels straight only, such that a TV receiver may not normally receive the IR-based remote-controller signal if there is an unexpected obstacle between the remote-controller and the TV receiver. The RF-based remote-controller signal converts an IR key value into an RF signal, and transmits the resultant RF signal, such that it is completely almost unaffected by an obstacle positioned between the RF remote-controller and the TV receiver, and has a wide operation range.

Typically, the remote-controller has been designed to simultaneously output IR/RF signals or to output only the IR signal. Therefore, provided that a new method for allowing a digital-TV viewer or user to easily establish IR/RF input signals is developed on the condition that the remote-controller is determined to be a model capable of supporting the RF signal, the TV viewer or user may be very highly satisfied with the above-mentioned new method, resulting in high satisfaction.

### SUMMARY OF THE INVENTION

Therefore, the present invention has been made in view of the above problems, and it is an object of the present invention to provide a method and system for automatically detecting a remote-controller communication mode of digital electronic devices, and allowing a user to easily establish a desired remote-controller mode, such that it can establish automatic recognition of a remote-controller communication mode for use in digital electronic devices.

In accordance with the present invention, the above and other objects can be accomplished by a method for automatically recognizing/establishing a remote-controller communication mode for use in a digital electronic device, the method comprising the steps of: a) selecting a communication mode setup menu so as to allow a user to establish a remote-controller communication mode; b) allowing a remote-controller to generate a key input signal, and transmitting the key input signal to the digital electronic device; c) determining whether a Radio Frequency (RF) remote-controller signal is received; d) if the RF signal is received, controlling the digital electronic device to determine the remote-controller communication mode to be an RF mode, and outputting normal setup confirmation information; and e) allowing the user to check whether the remote-controller communication mode of the digital electronic device is switched to a user-desired mode.

Preferably, the step (a) for allowing the user to select the remote-controller communication mode setup menu is selected from an IR/RF (Infrared/Radio Frequency) automatic setup menu located under a remote-controller menu.

Preferably, the remote-controller generates a key input signal when the user presses a specific key for a predetermined period of time.

Preferably, the predetermined period of time is less than 1 second.

Preferably, the step (c) for determining whether the RF signal is received includes the step of: c1) determining whether a pre-assigned specific port of the digital electronic device receives the RF signal.

Preferably, the step (c1) for determining whether the RF signal is received in the pre-assigned specific port includes the step of: if the RF signal is successively received in the pre-assigned specific port for a predetermined period of time less than 300 ms, determining whether the RF signal is received.

Preferably, the method further includes the step of: f) establishing a security code of an RF remote-controller after the remote-controller communication mode is set to a Radio Frequency (RF) mode.

Preferably, the method further includes the step of: g) if the RF signal is not detected, determining whether an IR (Infrared) signal is received.

Preferably, the step (g) for determining whether the IR signal is received includes the step of: determining whether a pre-assigned specific port of the digital electronic device receives the IR signal.

Preferably, the method further includes the step of: if the IR signal is received, allowing the digital electronic device to determine a remote-controller communication mode to be an IR mode, and outputting normal setup confirmation information.

Preferably, the method further includes the step of: establishing a security code of an IR remote-controller after the remote-controller communication mode is set to an IR mode.

Preferably, the method further includes the step of: if the remote-controller is not switched to a user-desired mode, allowing the user to repeat steps from the step (a).

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a flow chart illustrating a conventional IR/RF remote-controller input setup method in accordance with a preferred embodiment of the present invention;

FIG. 2 is a block diagram illustrating a remote-controller input control system in accordance with a preferred embodiment of the present invention;

FIG. 3 is a block diagram illustrating a method for automatically establishing remote-controller RF/IR modes for use in a digital TV in accordance with a preferred embodiment of the present invention;

FIG. 4 exemplarily shows an initial menu for a remote-controller setup operation in accordance with a preferred embodiment of the present invention;

FIG. 5 exemplarily shows a current remote-controller setup status serving as sub-menus of the system shown in FIG. 4 in accordance with a preferred embodiment of the present invention;

FIG. 6 exemplarily shows a menu displayed when a user sets a remote-controller input mode to an RF remote-controller mode in accordance with a preferred embodiment of the present invention; and

FIG. 7 exemplarily shows a menu displayed when a user sets a remote-controller to an IR remote-controller mode in accordance with a preferred embodiment of the present invention.

### DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

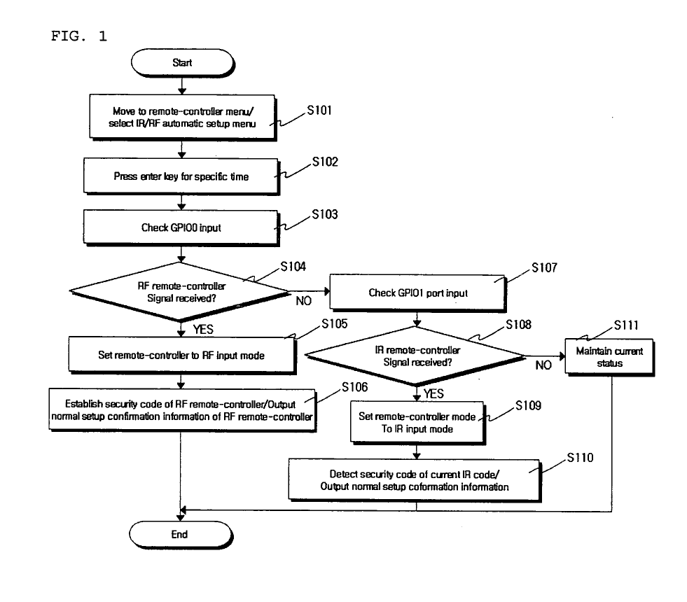

FIG. 1 is a flow chart illustrating a conventional IR/RF remote-controller input setup method in accordance with a preferred embodiment of the present invention.

Referring to FIG. 1, the conventional IR/RF remote-controller input setup method allows a user to go to a remote-controller menu, and the user clicks on or presses the Enter key, such that the IR/RF automatic setup menu is activated at step S101.

In this case, a User Interface (UI) menu commands the user to press the Enter key for a predetermined period of time (e.g., about 1 second) at step S102. A remote-controller input control program checks the presence or absence of a specific port “GPIO0” input state at step S103. If a normal RF remote-controller signal is received for a predetermined time of 300 ms, the input remote-controller mode of the digital TV is set to an RF mode, and determines a current RF remote-controller input security code at steps S104 and S105. Thereafter, the Enter key signal is discarded, and specific information indicating that the RF remote-controller is normally established along with the currently-received RF remote-controller's security code is displayed on a screen at step S106. If no input signal is applied to the GPIO0 port or a normal RF signal is not applied to the GPIO1 port, a remote-controller input mode is set to an IR mode, the GPIO1 port detects/establishes a security code of a current IR code, and provides the TV screen with the above-mentioned information indicative of the IR mode and the security code at steps S107-S110. If the GPIO1 port detects no signal, a pre-established remote-controller type and a security code are maintained without any change at step S111.

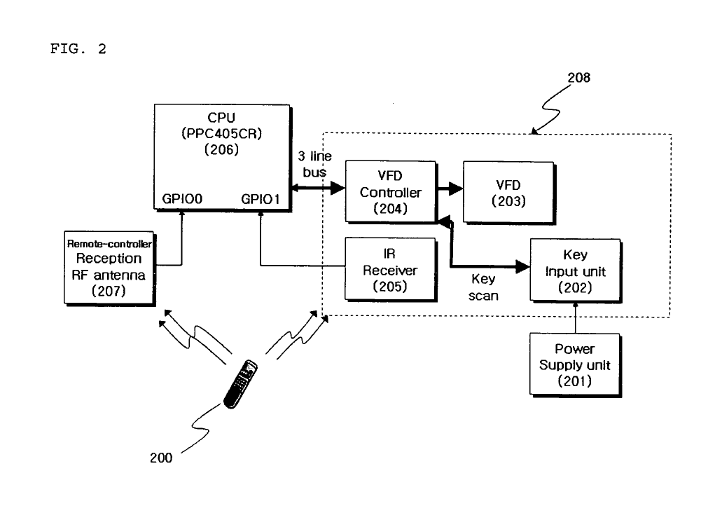

FIG. 2 is a block diagram illustrating a remote-controller input control system in accordance with a preferred embodiment of the present invention.

Referring to FIG. 2, a system for automatically recognizing/establishing a remote-controller communication mode for use in digital electronic devices according to the present invention includes a power-supply unit 201, a key entry unit 202, a display (denoted by “VFD”) 203, a VFD controller 204, a controller (denoted by “CPU”) 206, a remote-controller reception RF antenna 207, and an IR receiver 205.

In more detail, FIG. 2 is a block diagram illustrating a device for automatically recognizing/establishing a remote-controller communication mode of a digital TV from among digital electronic devices.

Referring to FIG. 2, the key entry unit 202 is indicative of a key (or button) input unit installed at the front part of a set-top box or digital TV. If a predetermined electric signal is applied to the key entry unit 202, the key entry unit 202 transmits the received electric signal to the VFD controller 203. The remote-controller reception RF antenna 207 receives the RF signal from the remote-controller 200. The IR receiver 205 receives the IR signal from the remote-controller 200. A specific port is assigned to the controller 206, such that the controller 206 receives a specific signal via the specific port. The system shown in FIG. 2 further includes a General Purpose (GPIO) Pin. The GPIO0 port detects an RF signal received from the remote-controller 200, and the GPIO1 port detects an IR signal. The controller 206 displays screen information on the VFD 203 according to an input signal received from the remote-controller 200. The VFD 203 is driven by a drive signal of the VFD controller 204.

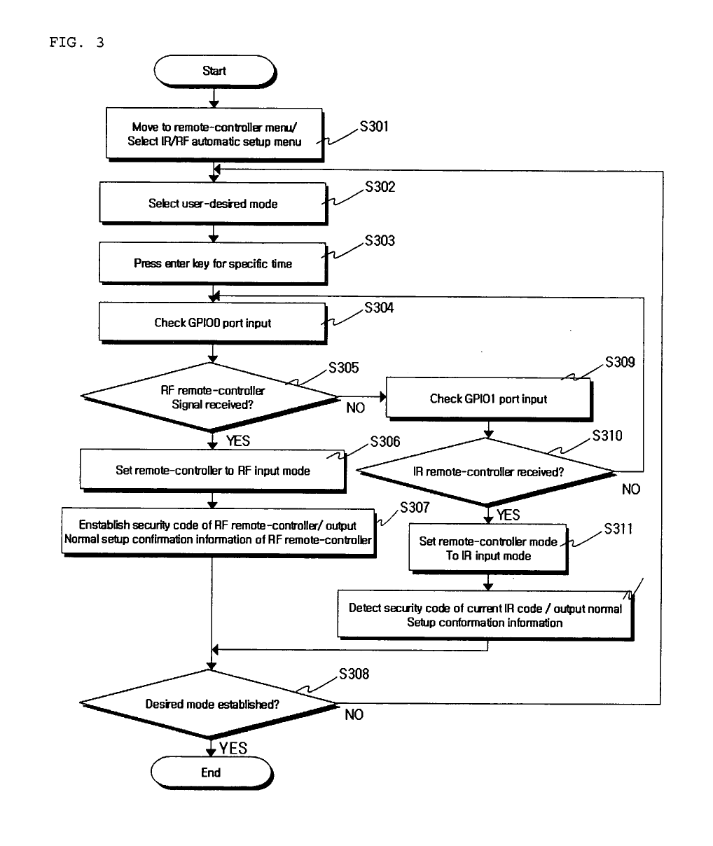

FIG. 3 is a block diagram illustrating a method for automatically recognizing/establishing remote-controller communication modes for use in a digital TV from among digital electronic devices in accordance with a preferred embodiment of the present invention.

A variety of remote-controller communication modes of the digital TV may exist in various ways according to various levels of those skilled in the art, but it is assumed that two remote-controller communication modes (i.e., an IR-based remote-controller communication mode and an RF-based remote-controller communication mode) are exemplarily used as the above-mentioned remote-controller communication mode for the convenience of description.

A method for automatically establishing RF/IR modes of the digital TV remote-controller will hereinafter be described with reference to FIG. 3.

Referring to FIG. 3, a user clicks on a remote-controller menu, clicks on or presses the IR/RF automatic setup menu, and selects a specific menu capable of establishing a remote-controller communication method from among a plurality of menus included in the digital TV at step 301.

FIG. 4 exemplarily shows a specific menu capable of establishing a remote-controller communication method from among a plurality of menus contained in the digital TV in accordance with a preferred embodiment of the present invention. Referring to FIG. 4, there are 6 optional menus, and 5 sub-menus are contained in a system menu located at the lowest end of the 6 optional menus. If the user selects the remote-controller menu located at the lowest end from among 5 sub-menus, the user can establish a desired remote-controller communication mode.

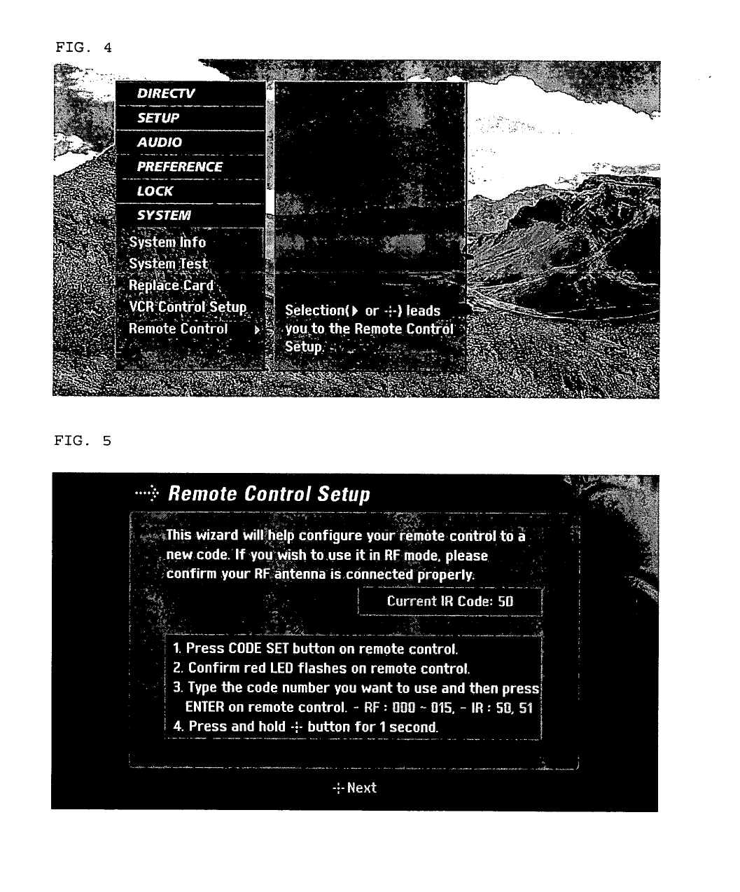

The user selects a desired mode at step S302. If the user selects his or her desired mode at step S302, the remote-controller setup menu of FIG. 5 is displayed.

A remote-controller key input signal is generated and transmitted at step 303. In more detail, the remote-controller key input signal is transmitted when the user presses a predetermined key for a predetermined period of time. According to the present invention, if the Enter key from among a plurality of remote-controller keys is pressed, a corresponding signal is generated. If the user presses the Enter key for a predetermined period of time, the remote-controller generates the RF signal, and the RF signal is transmitted to the digital TV. Although the time during which the Enter key is pressed may be implemented in various ways, it should be noted that the time is set to a predetermined time less than 1 second. Provided that the above-mentioned time is set to a predetermined time longer than 1 second, a long period of time is required as a recognition time, such that it is preferable that the time may be set to a short period of time.

The method shown in FIG. 3 searches for a specific port capable of receiving an RF signal from among a plurality of ports at step 304. The digital electronic device includes a predetermined receiver to receive the RF signal. A specific port capable of receiving each specific signal is assigned to the receiver.

The preferred embodiment of the present invention shown in FIG. 3 includes a General Purpose Input/Output (GPIO) Pin. The GPIO0 port detects an RF signal received from the remote-controller 200. The GPIO1 port detects an RF signal. Therefore, if it is determined whether a predetermined signal is received in the GPIO0 port, it can be determined whether the remote-controller transmits the RF signal according to the determined result. If a signal is successively received in the GPIO port for a predetermined time less than 300 ms, it is preferable that the presence of the RF signal input is determined, resulting in a reduced signal recognition time.

It is determined whether the RF signal is received or not at step 305. The remote-controller communication mode is set to an RF mode at step 306. If the RF signal transmitted from the remote-controller is detected from the GPIO0 port, the remote-controller communication mode of the current television (TV) is switched to the RF mode.

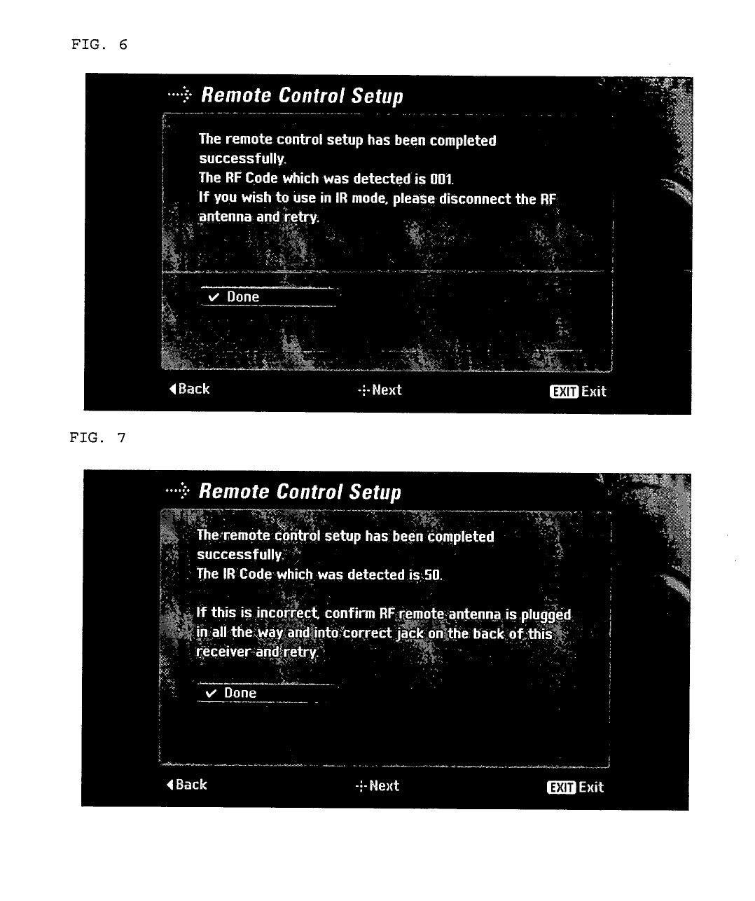

A security code of the RF remote-controller is established, and normal setup check information of the RF remote-controller is generated at step 307. The remote-controller communication mode of the digital TV is set to the RF mode, and the security code of the current RF remote-controller can be established. After the security code is established, the digital TV displays specific information indicating that the communication mode is switched to the RF mode on a screen. FIG. 6 shows an exemplary screen image indicating that the remote-controller communication mode is switched to the RF mode. Referring to FIG. 6, a current mode is determined to be the RF mode, and at the same time it can be recognized that the current RF code is equal to “001”.

It is determined whether a remote-controller communication mode is correctly changed to a user-desired mode at step 308. If erroneous recognition occurs in the digital TV, such that a remote-controller communication mode is changed to a user-undesired mode, the above-mentioned step 308 is repeated, such that a correct communication mode can be recognized. Referring to FIG. 6, if normal setup confirmation information of the RF remote-controller is generated and at the same time a currently-established communication mode is not desired by the user, the communication mode is terminated, and at the same time a specific image for querying the user for setup re-execution is displayed.

A specific port capable of receiving the IR signal is found at step 309. If a predetermined RF signal is not applied to the specific port capable of receiving the RF signal at steps 304 and 305, it is determined whether a predetermined IR signal is applied to a specific port (i.e., the GPIO1 port) capable of receiving the IR signal at step 309.

Steps 310˜312 are equal to the above steps 305˜307. However, a current communication mode is switched to the RF mode at steps 305˜307, and a current communication mode is switched to the IR mode at steps 310˜312, such that those skilled in the art will easily appreciate the above-mentioned steps, and detailed description thereof will herein be omitted for the convenience of description, However, if no IR signal is received at step 310, the RF signal is re-detected by repeatedly performing steps from the above step 304.

As apparent from the above description, a method and system for automatically recognizing/establishing a remote-controller communication mode of a digital electronic device according to the present invention can automatically detect a remote-controller input signal of the digital electronic device, and can easily establish a user-desired communication mode, such that the possibility of a malfunction in the digital electronic device is reduced, and users of the digital electronic device can easily and conveniently select a remote-controller input mode or signal.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for automatically recognizing/establishing a remote-controller communication mode for use in a digital electronic device, the method comprising the steps of:
a) selecting a communication mode setup menu so as to allow a user to establish a remote-controller communication mode;
b) allowing a remote-controller to generate a key input signal, and transmitting the key input signal to the digital electronic device;
c) determining whether a Radio Frequency (RF) remote-controller signal is received;
d) if the RF signal is received, controlling the digital electronic device to determine the remote-controller communication mode to be an RF mode, and outputting normal setup confirmation information; and
e) allowing the user to check whether the remote-controller communication mode of the digital electronic device is switched to a user-desired mode.

2. The method according to claim 1, wherein the step (a) for allowing the user to select the remote-controller communication mode setup menu is selected from an IR/RF (Infrared/Radio Frequency) automatic setup menu located under a remote-controller menu.

3. The method according to claim 1, wherein the remote-controller generates a key input signal when the user presses a specific key for a predetermined period of time.

4. The method according to claim 3, wherein the predetermined period of time is less than 1 second.

5. The method according to claim 1, wherein the step (c) for determining whether the RF signal is received includes the step of:
c1) determining whether a pre-assigned specific port of the digital electronic device receives the RF signal.

6. The method according to claim 5, wherein the step (c1) for determining whether the RF signal is received in the pre-assigned specific port includes the step of:
if the RF signal is successively received in the pre-assigned specific port for a predetermined period of time less than 300 ms, determining whether the RF signal is received.

7. The method according to claim 1, further comprising the step of:
f) establishing a security code of an RF remote-controller after the remote-controller communication mode is set to a Radio Frequency (RF) mode.

8. The method according to claim 1, further comprising the step of:
g) if the RF signal is not detected, determining whether an IR (Infrared) signal is received.

9. The method according to claim 8, wherein the step (g) for determining whether the IR signal is received includes the step of:
determining whether a pre-assigned specific port of the digital electronic device receives the IR signal.

10. The method according to claim 8, further comprising the step of:
if the IR signal is received, allowing the digital electronic device to determine a remote-controller communication mode to be an IR mode, and outputting normal setup confirmation information.

11. The method according to claim 10, further comprising the step of:
establishing a security code of an IR remote-controller after the remote-controller communication mode is set to an IR mode.

12. The method according to claim 1, further comprising the step of:
if the remote-controller is not switched to a user-desired mode, allowing the user to repeat steps from the step (a).

13. The method according to claim 1, further comprising the step of:
if the remote-controller is not switched to a user-desired mode, maintaining current status.

14. A digital electronic device comprising:
a component for automatically recognizing/establishing a remote-controller communication mode according to the method of claim 1.
